(19) United States
(12) Patent Application Publication
(10) Pub. No.: US 2014/0175868 A1
(43) Pub. Date: Jun. 26, 2014

(54) ELECTRIC POWER SUPPLY APPARATUS, CONTACTLESS ELECTRICITY TRANSMISSION APPARATUS, VEHICLE, AND CONTACTLESS ELECTRIC POWER TRANSFER SYSTEM

(71) Applicants: Hiroyuki Sakakibara, Hekinan-shi (JP); Shinji Ichikawa, Toyota-shi (JP)

(72) Inventors: Hiroyuki Sakakibara, Hekinan-shi (JP); Shinji Ichikawa, Toyota-shi (JP)

(73) Assignees: NIPPON SOKEN, INC., Nishio, Aichi (JP); TOYOTA JIDOSHA KABUSHIKI KAISHA, Toyota-shi, Aichi-ken (JP)

(21) Appl. No.: 14/234,409

(22) PCT Filed: Jul. 25, 2012
(86) PCT No.: PCT/IB2012/001433

§ 371 Date: Jan. 23, 2014

(30) Foreign Application Priority Data
Jul. 28, 2011 (JP) 2011-165524

(51) Int. Cl. H01F 38/14; H02M 3/155

(52) U.S. Cl. CPC H01F 38/14; H02M 3/155
USPC 307/9.1; 307/104; 323/351

(57) ABSTRACT

An electric power supply apparatus includes a choke coil, a switching element, a resonance circuit and a compensation circuit. The parasitic capacitance of the switching element is larger than a predetermined capacitance needed for realizing class E zero-voltage switching. The compensation circuit is connected in parallel with the switching element. The compensation circuit includes a coil and a capacitor, and has inductive impedance.

### BACKGROUND OF THE INVENTION

1. Field of the Invention

The invention relates to an electric power supply apparatus, a contactless electricity transmission apparatus, a vehicle, and a contactless electric power transfer system. Particularly, the invention relates to a technology of a high-frequency electric power supply for use in the contactless electric power transfer.

2. Description of the Related Art

A class E amplifier circuit capable of producing electric power of high frequency with low loss (also referred to as “class E zero-voltage switching (ZVS) circuit”) is known. In the class E amplifier circuit, a switching element turns on when the voltage across the switching element is zero and the gradient of the voltage is also zero (zero-voltage switching), the switching loss can be lessened. Thus, the class E amplifier circuit is useful particularly in a high-frequency electric power supply.

Japanese Patent Application Publication No. 7-142937 (JP 7-142937 A) discloses a construction of such a class E amplifier circuit. In general, the class. E amplifier circuit includes a choke coil, a switching element, a shunt capacitor connected in parallel with the switching element, and an inductor and a capacitor that are connected in series between the choke coil and a load. In the class E amplifier circuit, a series resonance circuit made up of an inductor and a capacitor that are connected in series is provided in parallel with the switching element and the shunt capacitor.

Due to this construction, the class E amplifier circuit allows a permissible range in design to be given to a relation among the input electric power, the output electric power and the load resistance of the class E amplifier circuit (see Japanese Patent Application Publication No. 7-142937 (JP 7-142937 A)).

Japanese Patent Application Publication No. 2011-30298 (JP 2011-30298 A) discloses a wireless electric power feeder apparatus that has a high-frequency electric power supply. In this wireless electric power feeder apparatus, an electric power supply control circuit produces high-frequency electric power. Then, from a power feeding coil supplied with the high-frequency electric power produced by the electric power supply control circuit, electric power is transferred to a power receiving coil by magnetic field resonance (see JP 2011-30298 A).

By using the class E amplifier circuit in a high-frequency electric power supply of a wireless electric power feeder apparatus as described above, an electric power supply apparatus with low loss can be constructed and the efficiency of contactless electric power transfer can be improved. In order to realize electric power transfer of large power, it is necessary to increase the rated voltage or the rated current of the switching element of the class E amplifier circuit for use in an electric power supply apparatus. Since the rating of a switching element has an, upper limit, a switching element with a large rated current can be constructed in an equivalent fashion by connecting a plurality of switching elements in parallel.

In the switching element, a parasitic capacitance exists. If the switching element is increased in size or a plurality of switching elements are connected in parallel in order to realize large electric power transfer, the parasitic capacitance of the entire switching element increases. If the parasitic capacitance becomes large, it becomes impossible to, achieve the zero-voltage switching when the switching element turns on, so that an increased loss results.

### SUMMARY OF THE INVENTION

The invention provides an electric power supply apparatus, a contactless electricity transmission apparatus, a vehicle, and a contactless electric power transfer system that are equipped with an amplifier circuit that carries out the zero-voltage switching even when the parasitic capacitance of the switching element is large.

A first aspect of the invention is related to an electric power supply apparatus. The electric power supply apparatus includes: an amplifier circuit that includes a switching element whose parasitic capacitance is larger than a predetermined capacitance that is needed in order to realize class E zero-voltage switching; and a compensation circuit that is connected in parallel with the switching element and that has inductive impedance.

In the above aspect, the amplifier circuit may further include: a first inductor connected between the switching element and a direct-current power supply; and a resonance circuit connected between a connecting node between the first inductor and the switching element and a load connected to the amplifier circuit.

In the above aspect, the compensation circuit may include a second inductor and a capacitance element that are connected in series.

In the above aspect, the inductance of the second inductor may be set at such a value that resonance frequency of a circuit formed by the second inductor and the parasitic capacitance of the switching element is substantially equal to switching frequency of the switching element.

In the above aspect, the capacitance of the capacitance element may be set so that magnitude of impedance of the capacitance element is at least ten times the magnitude of the impedance of the second inductor.

In the above aspect, the predetermined capacitance may be determined by switching frequency of the switching element and a load that is connected to the amplifier circuit.

In the above aspect, the predetermined capacitance may be found by an expression below:

C=8/{π(π²+4)ωR}

where ω=2πf, and f represents operating frequency, and R represents magnitude of the load.

In the above aspect, the switching element may be constructed of a plurality of switching elements that are connected in parallel with each other.

A second aspect of the invention is related to a contactless electricity transmission apparatus that outputs electric power to an electricity reception apparatus in a contactless manner. The contactless electricity transmission apparatus includes: an electric power supply portion that produces alternating-current power; and an electricity-transmitting resonance portion configured so that alternating-current power supplied from the electric power supply portion is output to an electricity-receiving resonance portion of the electricity reception apparatus in a contactless manner. The natural frequency of the electricity-transmitting resonance portion is equal to the natural frequency of the electricity-receiving resonance portion. The electric power supply portion includes an amplifier circuit that includes a switching element whose parasitic capacitance is larger than a predetermined capacitance that is needed in order to realize class E zero-voltage switching, and a compensation circuit that is connected in parallel with the switching element and that has inductive impedance.

In the above aspect, the amplifier circuit may further include: a first inductor connected between the switching element and a direct-current power supply; and a resonance circuit connected between a connecting node between the first inductor and the switching element and the electricity-transmitting resonance circuit.

In the above aspect, the compensation circuit may include a second inductor and a capacitance element that are connected in series.

In the above aspect, the inductance of the second inductor may be set at such a value that resonance frequency of a circuit formed by the second inductor (262) and the parasitic capacitance of the switching element is substantially equal to switching frequency of the switching element.

In the above aspect, the capacitance of the capacitance element may be set so that magnitude of impedance of the capacitance element is at least ten times the magnitude of the impedance of the second inductor.

In the above aspect, the predetermined capacitance may be determined by switching frequency of the switching element and a load that is connected to the amplifier circuit.

In the above aspect, the predetermined capacitance is found by an expression below:

C=8/{π(π²+4)ωR}

where ω=2πf, and f represents operating frequency, and R represents magnitude of the load.

In the above aspect, the switching element may be constructed of a plurality of switching elements that are connected in parallel with each other.

In the above aspect, the electricity-transmitting resonance portion may transmit electricity to the electricity-receiving resonance portion through at least one of i) a magnetic field that is formed between the electricity-transmitting resonance portion and the electricity-receiving resonance portion and that oscillates at a specific frequency and, ii) an electric field that is formed between the electricity-transmitting resonance portion and the electricity-receiving resonance portion and that oscillates at a specific frequency.

In the above aspect, a coupling coefficient κ of the electricity-transmitting resonance portion and the electricity-receiving resonance portion may be less than or equal to 0.1.

In the above aspect, the electricity-transmitting resonance portion and a coil of the electricity-receiving resonance portion may have a relation in which a multiplication production of the coupling coefficient κ and a Q value is greater than or equal to 1.0.

A third aspect of the invention is related to a vehicle that outputs electric power to a load provided outside the vehicle in a contactless manner. The vehicle includes: an electricity storage apparatus; an electric power supply portion that receives electric power from the electricity storage apparatus and produces alternating-current power; and a resonance portion configured to output the alternating-current power supplied from the electric power supply portion to an electricity-receiving resonance portion provided at a side of the load, in a contactless manner. The natural frequency of the resonance portion is the same as the natural frequency of the electricity-receiving resonance portion. The electric power supply portion includes: an amplifier circuit that includes a switching element whose parasitic capacitance is larger than a predetermined capacitance that is needed in order to realize class E zero-voltage switching; and a compensation circuit that is connected in parallel with the switching element and that has inductive impedance.

A fourth aspect of the invention is related to a contactless electric power transfer system that transfers electric power from an electricity transmission apparatus to an electricity reception apparatus in a contactless manner. The electricity transmission apparatus includes an electric power supply portion that produces alternating-current power, and an electricity-transmitting resonance portion configured to output the alternating-current power supplied from the electric power supply portion to the electricity reception apparatus in a contactless manner. The electricity reception apparatus includes an electricity-receiving resonance portion configured to receive the electric power from the electricity-transmitting resonance portion in a contactless manner. The natural frequency of the electricity-receiving resonance portion is the same as the natural frequency of the electricity-transmitting resonance portion. The electric power supply portion includes an amplifier circuit that includes a switching element whose parasitic capacitance is larger than a predetermined capacitance that is needed in order to realize class E zero-voltage switching, and a compensation circuit that is connected in parallel with the switching element and that has inductive impedance.

In the case where the parasitic capacitance of the switching element of the amplifier circuit is larger than a predetermined capacitance for realizing the class E zero-voltage switching, the zero-voltage switching cannot be realized if the state is left as it is. Therefore, in the invention, a compensation circuit that is connected in parallel with the switching element and that has inductive impedance is provided. Due to this, the discharge of the parasitic capacitance of the switching element is quickened or accelerated by the compensation circuit.

Hence, according to the invention, the zero-voltage switching can be realized even in the case where the parasitic capacitance of the switching element is large. As a result, contactless electric power transfer of large electric power can be realized with high efficiency.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is an overall construction diagram of a contactless electric power transfer system to which an electric power supply apparatus according to a first embodiment of the invention is applied;

FIG. 2 is a diagram for describing the principle of contactless electricity transmission by magnetic field resonance;

FIG. 3 is a circuit diagram of the electric power supply apparatus shown in FIG. 1;

FIG. 4 is a waveform diagram of a typical class E amplifier circuit in an ideal state;

FIG. 5 is a waveform diagram of a related-art class E amplifier circuit in the case where the parasitic capacitance of the switching element exceeds a theoretical capacitance;

FIG. 6 is a waveform diagram of the electric power supply apparatus of the first embodiment;

FIG. 7 is a circuit diagram of the electric power supply apparatus; and

FIG. 8 is an overall construction diagram of a vehicle to which an electric power supply apparatus according to a second embodiment of the invention is applied.

### DETAILED DESCRIPTION OF EMBODIMENTS

Embodiments of the invention will be described in detail hereinafter with reference to the drawings. The same or comparable portions in the drawings are denoted by the same reference characters, and descriptions thereof will not be repeated below.

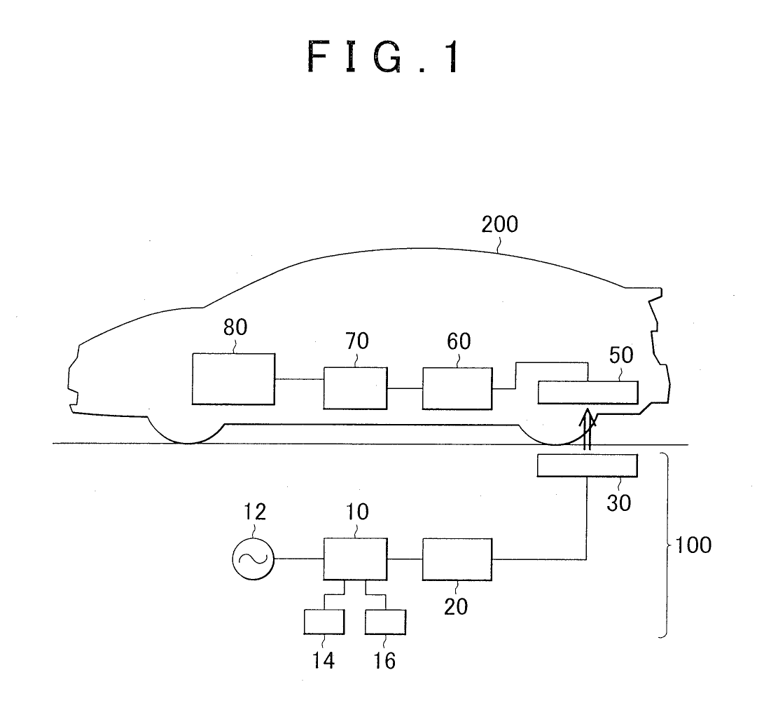

FIG. 1 is an overall construction diagram of a contactless electric power transfer system to which an electric power supply apparatus according to a first embodiment of the invention is applied. Referring to FIG. 1, this contactless electric power transfer system includes an electricity transmission apparatus 100 and a vehicle 200. The electricity transmission apparatus 100 includes a power controller 10, an electric power supply apparatus 20, and a resonance unit 30. The vehicle 200 includes a resonance circuit 50, a rectifier circuit 60, an electricity storage apparatus 70, and a motive power production apparatus 80.

The power controller 10 is supplied with electric power from, for example, a network electric power supply 12, a solar battery 14, an electricity storage apparatus 16, etc. Then, the power controller 10 produces a constant direct-current voltage, and supplies the produced direct-current voltage to the electric power supply apparatus 20.

The electric power supply apparatus 20, receiving electric power from the power controller 10, produces alternating-current power of high frequency. This electric power supply apparatus 20 employs an amplifier circuit that is capable of outputting large electric power and of operating with low loss by performing zero-voltage switching. The circuit construction of the electric power supply apparatus 20 will be described in detail later.

The resonance unit 30 is supplied with the alternating-current power of high frequency from the electric power supply apparatus 20, and transfers electric power to the resonance unit 30 in a contactless manner. As an example, the resonance unit 30 is constructed of a resonance circuit that includes a coil and a capacitor.

On the other hand, in the vehicle 200, the resonance unit 30 receives, in a contactless manner, the electric power sent out from the resonance unit 30 of the electricity transmission apparatus 100, and then outputs electric power to the rectifier circuit 60. As an example, the resonance unit 50, too, is constructed of a resonance circuit that includes a coil and a capacitor.

The rectifier circuit 60 converts the alternating-current power received from the resonance unit 80 into direct-current power, and outputs the converted direct-current power to the electricity storage apparatus 70, and thereby charges the electricity storage apparatus 70. The electricity storage apparatus 70 is a rechargeable direct-current power supply, and is constructed of, for example, secondary batteries of a lithium ion type, a nickel metal hydride type, etc. The electricity storage apparatus 70 also stores electric power that is generated by the motive power production apparatus 80 as well as the electric power input from the rectifier circuit 60. The electricity storage apparatus 70 supplies electric power stored therein to the motive power production apparatus 80. It is to be noted that it is also possible to adopt a capacitor of large capacitance as the electricity storage apparatus 70.

The motive power production apparatus 80 produces drive force for the vehicle 200 by using electric power stored in the electricity storage apparatus 70. Although not particularly shown in the drawings, the motive power production apparatus 80 includes, for example, an inverter that receives electric power from the electricity storage apparatus 70, an electric motor that is driven by the inverter, drive wheels that are driven by the electric motor, etc. The motive power production apparatus 80 may also include an electricity generator for charging the electricity storage apparatus 70, and an engine that is capable of driving the electricity generator.

In this contactless electric power transfer system, the natural frequency of the resonance unit 30 of the electricity transmission apparatus 100 is the same as the natural frequency of the resonance unit 50 of the vehicle 200. It is to be noted herein that the natural frequency of the resonance unit 30 (50) means an oscillation frequency that an electric circuit (resonance circuit) that constitutes the resonance unit 30 (50) has when it freely oscillates. Incidentally, the resonance frequency of the resonance unit 30 (50) means the natural frequency that the electric circuit (resonance circuit) that constitutes the resonance unit 30 (50) has when the braking force or the electric resistance is zero.

Furthermore, natural frequencies being “the same” includes not only the natural frequencies being perfectly the same but also the natural frequencies being substantially the same. Natural frequencies being “substantially the same” means, for example, the case where a difference between the natural frequency of the resonance unit 30 and the natural frequency of the resonance unit 50 is less than or equal to 10% of the natural frequency of the resonance unit 30 or of the resonance unit 50.

The resonance unit 30 transmits electricity to the resonance unit 50 of the vehicle 200 through at least one of a magnetic field that is formed between the resonance units 30 and 50 and that oscillates at a specific frequency and an electric field that is formed between the resonance units 30 and 50 and that oscillates at a specific frequency. The resonance unit 30 and the resonance unit 50 are designed so that a coupling coefficient κ of the resonance unit 30 and the resonance unit 50 is less than or equal to 0.1 and the multiplication product of the coupling coefficient κ and the Q value is greater than or equal to a predetermined value (e.g., 1.0). By causing the resonance unit 30 and the resonance unit 50 to resonate in an electromagnetic field in the above-described manner, electric power is transferred in a contactless manner from the resonance unit 30 of the electricity transmission apparatus 100 to the resonance unit 50 of the vehicle 200.

In the contactless electric power transfer system, electric power is transferred from the resonance unit 30 to the resonance unit 50 in a contactless manner by causing the resonance unit 30 and the resonance unit 50 to resonate in an electromagnetic field, as described above. The coupling between the resonance unit 30 and the resonance 50 as described above in electric power transfer is referred to as, for example, “magnetic resonance coupling”, “magnetic field resonance coupling”, “electromagnetic field resonance coupling”, “electric' field resonance coupling”, etc. The “electromagnetic field resonance coupling” means coupling that includes “magnetic resonance coupling”, “magnetic field resonance coupling” and “electric field resonance coupling”.

In the case where the resonance unit 30 and the resonance unit 50 are each formed by a coil as described above, the resonance unit 30 and the resonance unit 50 are coupled mainly by a magnetic field to form a “magnetic resonance coupling” or a “magnetic field resonance coupling”. Each of the resonance unit 30 and the resonance unit 50 may also employ an antenna, for example, a meander line antenna or the like. In that case, the resonance unit 30 and the resonance unit 50 couple mainly by an electric field to form an “electric field resonance coupling”.

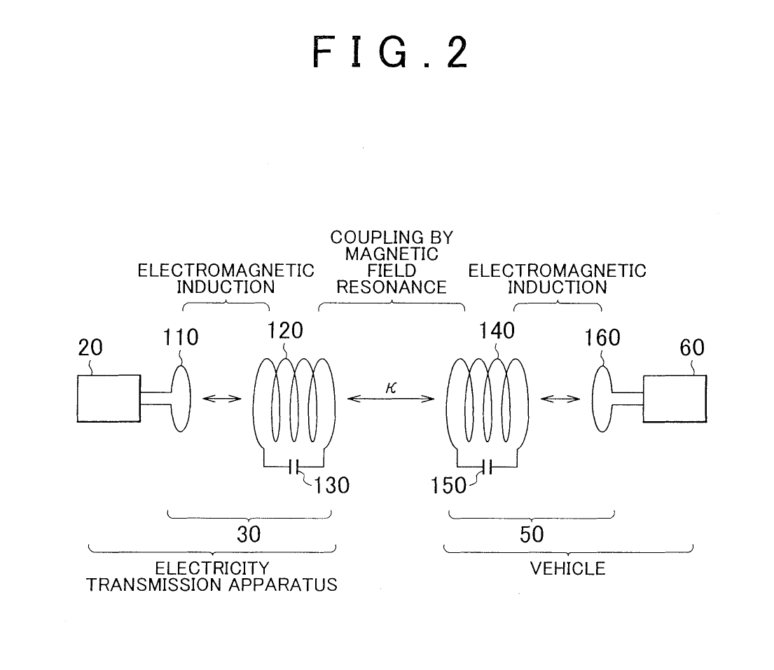

FIG. 2 is a diagram for describing the principle of the contactless electricity transmission realized by the magnetic field resonance. Referring to FIG. 2, in this electricity transmission technique, two resonance coils that have the same natural frequency resonate with each other in a magnetic field (that may instead be an electric field) similarly to two tuning forks resonating with each other, so that electric power is transferred from one of the coils to the other coil via the magnetic field.

Concretely, the resonance unit 30 of the electricity transmission apparatus 100 side is constructed by the electromagnetic induction coil 110 and the resonance coil 120. The resonance coil 120 is supplied with high-frequency electric power from the electric power supply apparatus 20 by using the electromagnetic induction coil 110 connected to the electric power supply apparatus 20. The resonance unit 50 of the vehicle 200 side is similarly constructed of the resonance coil 140 and the electromagnetic induction coil 160. The resonance coil 120, together with the capacitor 130, forms an LC resonator, and resonates, in the magnetic field, with the resonant coil 140 of the vehicle 200 side which has the same natural frequency as the resonance coil 120. When the resonance coils 120 and 140 resonate, energy (electric power) moves from the resonance coil 120 to the resonance coil 140 via the magnetic field. Energy (electric power) that has moved to the resonance coil 140 is extracted from the resonance coil 140 by using the electromagnetic induction coil 160, and the extracted energy is output to the rectifier circuit 60 (see FIG. 1).

The electromagnetic induction coil 110 is provided for facilitating the feeding of electricity from the electric power supply apparatus 20 to the resonance coil 120. The electric power supply apparatus 20 may also be connected directly to the resonance coil 120, without providing the electromagnetic induction coil 110. Furthermore, the floating capacitance of the resonance coil 120 may be utilized to make a construction in which the capacitor 130 is not provided.

Likewise, the electromagnetic induction coil 160 is provided for facilitating the extraction of electric power from the resonance coil 140. The rectifier circuit 60 may be connected directly to the resonance coil 140 without providing the electromagnetic induction coil 160. Furthermore, the floating capacitance of the resonance coil 140 may be utilized to make a construction in which the capacitor 150 is not provided.

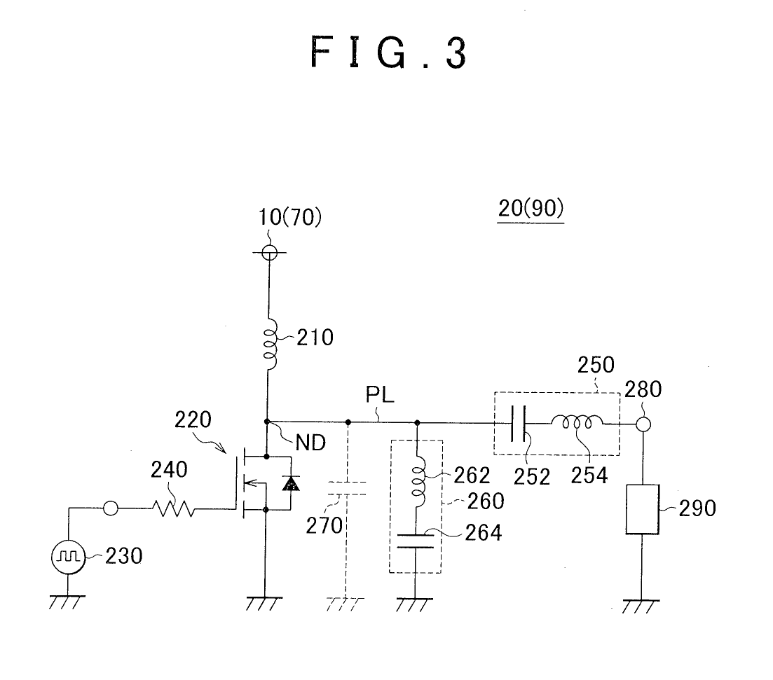

FIG. 13 is a circuit diagram of the electric power supply apparatus 20 shown in FIG. 1. Referring to FIG. 3, the electric power supply apparatus 20 includes a choke coil 210, a switching element 220, a pulse generator 230, a gate resistance 240 (a resistance is represented by a zigzag line in the drawings), a resonance circuit 250, a compensation circuit 260, and an output terminal 280.

The choke coil 210 is connected between the power controller 10 (FIG. 1) and a node ND. The switching element 220 is connected to the node ND. The resonance circuit 250 is connected between the node ND and the output terminal 280. A load 290 (a load is represented by a rectangle in the drawings) is connected to the output terminal 280. The load 290 collectively represents the loads that include the resonance unit 30 (FIG. 1) and other loads that are provided to the far side of the resonance unit 30 from the electric power supply apparatus 20. The compensation circuit 260 is connected to an electric power line PL between the node ND and the resonance circuit 250. That is, the compensation circuit 260 is connected in parallel with the switching element 220.

The choke coil 210 causes the electric current from the power controller 10 to be substantially constant. That is, the inductance of the choke coil 210 is set large so that the current that the choke coil 210 receives from the power control 10 can be made substantially constant.

The switching element 220 is turned on and off (subjected to on/off driving) by a gate drive circuit that is made up of the pulse generator 230 and the gate resistance 240. In order to enhance the electricity feeding capability of the electricity transmission apparatus 110, the switching element 220 is provided with large rating. Therefore, the switching 220 has a large parasitic capacitance. The switching element 220 employs a power MOSFET (Metal Oxide Semiconductor Field-Effect Transistor) in a representative construction; however, instead of the power MOSFET, a power transistor, such as an IGBT (Insulated Gate Bipolar Transistor) or the like, may also be used. A diode is connected in reverse-parallel with the switching element 220.

The pulse generator 230 generates a pulse signal (having a duty ratio of 50%) for turning on and off the switching element 220. The frequency of the pulse signal that the pulse generator 230 generates is the frequency of the alternating-current power that is produced by the electric power supply apparatus 20. The gate resistance 240 is provided for preventing parasitic oscillations and the like.

The resonance circuit 250 includes a capacitor 252 and a coil 254 that are connected in series. As for the resonance circuit 250, the capacitor 252 and the coil 254 are designed so as to have a natural frequency near the frequency of the alternating-current power produced by the electric power supply apparatus 20.

The compensation circuit 260 includes a coil 262 and a capacitor 264 that are connected in series. This compensation circuit 260 has an inductive impedance, and is provided for quickening or accelerating the discharge of the parasitic capacitance of the switching device 220. Hereinafter, this will be described in detail.

The specifications of the choke coil 210, the switching element 220 and the resonance circuit 250 are determined according to the design theory of the class E amplifier circuit, on the basis of the operating frequency and the output electric power of the electric power supply apparatus 20, and the load 290 of the apparatus 20. In a typical class E amplifier circuit, a capacitor is connected in parallel with a switching element, in order to delay the rising of voltage and thereby cause the output waveform to be similar or equal to a sine wave. The specifications of this capacitor are determined according to the design theory of the class E amplifier circuit on the basis of the operating frequency of the class E amplifier circuit and the load of output of the class E amplifier circuit, for example, by expression (1).

C=8/{π(π²+4)ωR} (1)

where ω=2πf, and f represents the operating frequency, and R represents the magnitude of the load.

Since the switching element has parasitic capacitance, the capacitance of the capacitor connected in parallel with the switching element needs to be determined by subtracting the parasitic capacitance of switching element from the value calculated as mentioned above.

On another hand, in the electric power supply apparatus 20 in the first embodiment, the switching element 220 has large rating in order to achieve a large electricity feeding capability of the electricity transmission apparatus 100. As a result, a parasitic capacitance 270 of the switching element 220 is also large; more specifically, the parasitic capacitance 270 exceeds the capacitance given by the expression (1). Therefore, the electric power supply apparatus 20 is not provided with a capacitor that, in a typical class E amplifier circuit, is connected in parallel with the switching element.

In the case where the parasitic capacitance of the switching element exceeds the capacitance given by the expression (1), the zero-voltage switching cannot be realized when the switching element turns on, if the state is left as it is. Therefore, in the first embodiment, the compensation circuit 260 that has an inductive impedance is provided in parallel with the switching element 220 (the parasitic capacitance 270), so that the discharge of the parasitic capacitance 270 of the switching element is accelerated. Therefore, it becomes possible to realize the zero-voltage switching of the switching element 220 although the parasitic capacitance 270 is large.

The coil 262 of the compensation circuit 260 is designed so as to resonate with the parasitic capacitance 270 of the switching element 220 at the switching frequency of the switching element 220. That is, the inductance of the coil 262 is set so that the resonance frequency of the circuit formed by the coil 262 and the parasitic capacitance 270 of the switching element 220 becomes substantially equal to the switching frequency of the switching element 220. This makes it possible to achieve an appropriate amount of electric charge of the parasitic capacitance 270 and therefore realize the zero-voltage switching of the switching element 220.

The capacitor 264 of the compensation circuit 260 is provided for blocking direct current, and has a sufficiently large capacitance. As an example, the capacitance of the capacitor 264 is set so that the magnitude of the impedance of the capacitance 264 is at least ten times the magnitude of the impedance of the coil 262. Although not particularly shown in the drawings, the coil 262 and the capacitor 264 may be interchanged in position.

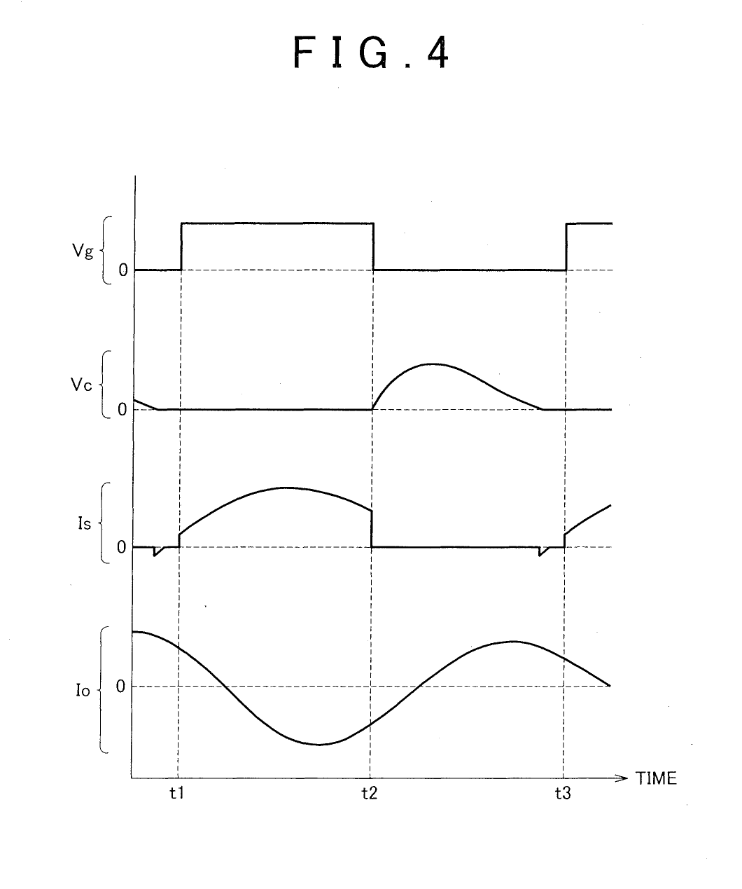

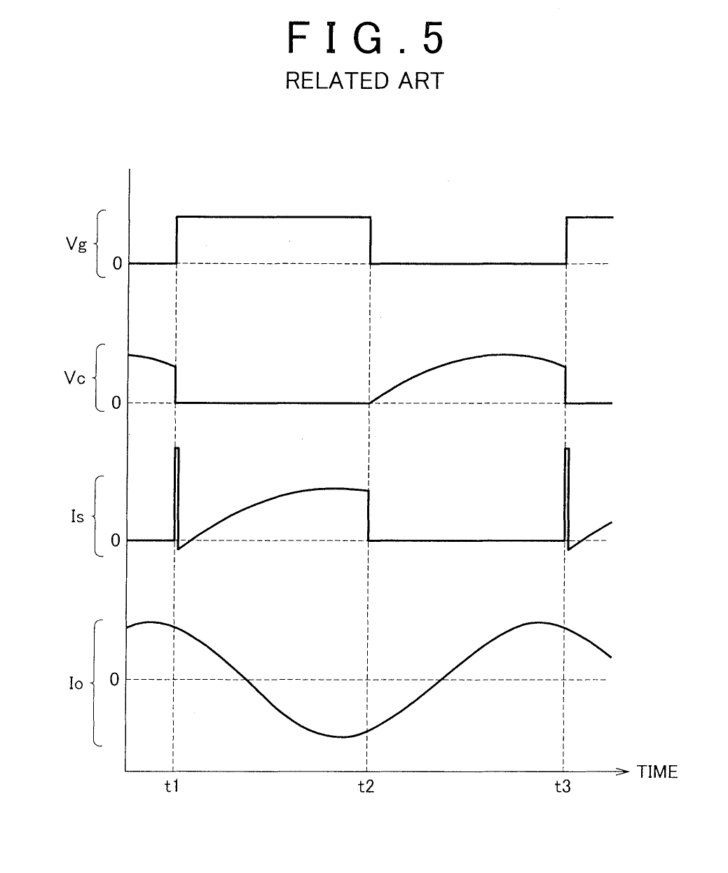

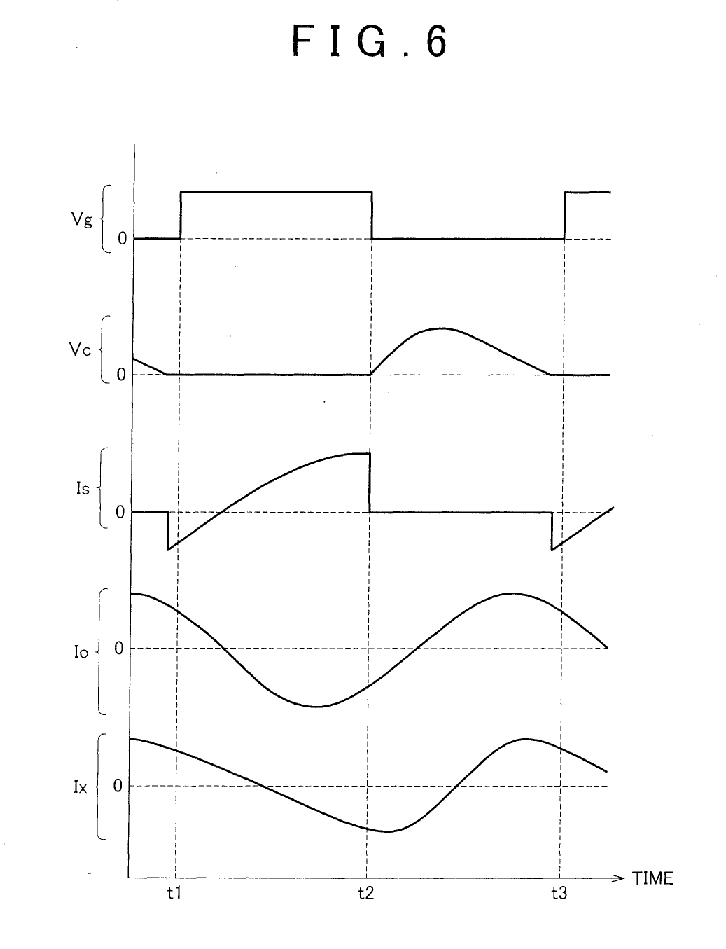

FIG. 4 is a waveform diagram of a typical class E amplifier circuit in the ideal state. The waveforms shown in FIG. 4 and in FIG. 5 (described later) are provided for comparison with the waveforms in the first embodiment shown in FIG. 6 (described later). Referring to FIG. 4, the voltage Vg represents the gate voltage of the switching element, and the voltage Vc represents the inter-terminal voltage of the capacitor that is connected in parallel with the switching element. Furthermore, the current Is represents the current that flows through the switching element, and the current Io represents the output current of the class E amplifier circuit.

At time t1, the voltage Vg arises, and the switching element turns on. While the switching element is on, the voltage Vc is substantially zero and the current Is flows through the switching element.

At time t2, the voltage Vg falls and the switching element turns off. The current Is becomes zero, and the capacitor connected in parallel with the switching element is charged, so that the voltage Vc increases. After that, due to the effect of the resonance circuit, the capacitor starts to discharge, and the voltage Vc declines. The capacitance of the capacitor has been designed on the basis of the expression (1) in order to realize the zero-voltage switching of the switching element. As a result, the voltage Vc becomes zero immediately before time t3 at which the switching element turns on.

Then, at time t3, the voltage Vg arises again, and the switching element turns on, with the voltage Vc being zero. That is, the zero-voltage switching of the switching element is realized.

On another hand, FIG. 5 is a waveform diagram in the case where the parasitic capacitance of the switching element is large in a related-art class E amplifier circuit. FIG. 5, too, is provided for comparison with the waveforms of the first embodiment shown in FIG. 6 (described later). Referring to FIG. 5, when the switching element turns off at time t2, the capacitor connected in parallel with the switching element is charged, so that the voltage Vc increases.

In this case, if the parasitic capacitance of the switching element is so large as to exceed the capacitance given by the expression (1), electrical charge remains in the parasitic capacitance at time t3 at which the switching element turns on, that is, the voltage Vc does not become zero at time t3. Hence, if in this state, the switching element turns on at time t3, short-circuit current flows through the switching element, resulting in large loss. That is, in this case, the zero-voltage switching is not realized.

FIG. 6 is a waveform diagram of the electric power supply apparatus 20 in the first embodiment. Referring to FIG. 6, the voltage Vc represents the voltage of the parasitic capacitance 270, that is, the drain-source voltage of the switching element, and the current Ix represents the electric current that flows through the coil 262 (FIG. 3) of the compensation circuit 260. When at time t2 the switching element turns off, the parasitic capacitance of the switching element 220 is charged, so that the voltage Vc increases.

In the first embodiment, since the compensation circuit 260 that has inductive impedance is provided (FIG. 3) in parallel with the switching element 220 (the parasitic circuit 270); the current Ix flows from the switching element 220 (the parasitic capacitance 270) to the compensation circuit 260 that has inductive impedance, after the switching element 220 turns off. Because the current Ix flows, the discharge of the parasitic capacitance 270 of the switching element 220 is accelerated, so that the voltage Vc becomes zero immediately before time t3 at which the switching element 220 turns on.

Then, at time t3, the voltage Vg arises again, and the switching element 220 turns on, with the voltage Vc being zero. That is, the zero-voltage switching of the switching element 220 is realized.

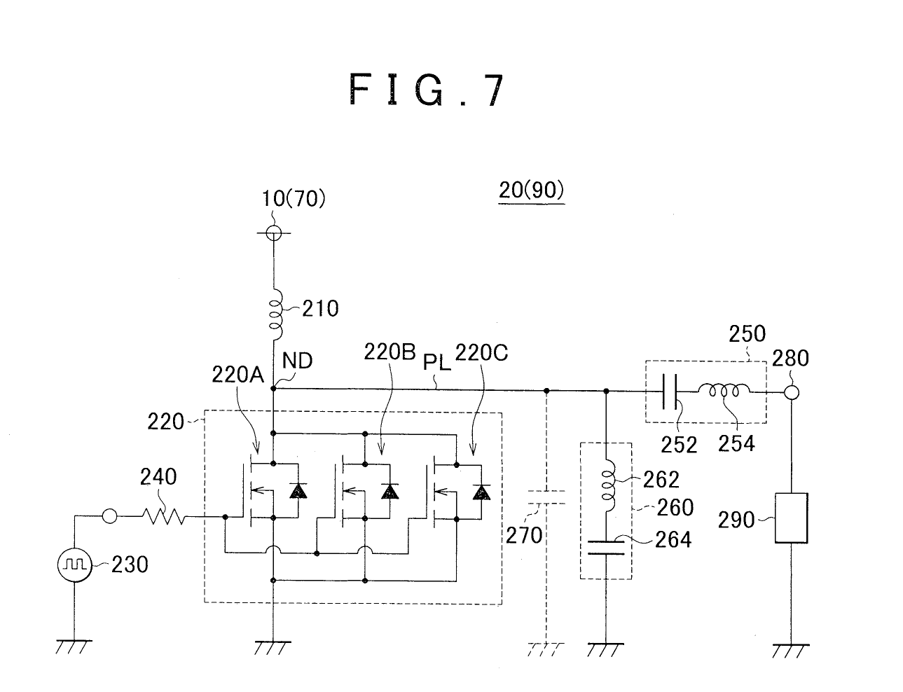

Incidentally, in the foregoing description, the switching element 220 has large rating in order to achieve large electricity feeding capability of the electricity transmission apparatus 100. However, taking into account that the rating of the switching element has an upper limit, the switching element 220 may be constructed by connecting a plurality of switching elements in parallel as shown in FIG. 7. FIG. 7 shows an example in which the switching element 220 is constructed of three switching elements 220A to 220C that are connected in parallel with each other. Typically, connecting a plurality of switching elements in parallel in this manner results in an increased parasitic capacitance of the entire switching element. However, in the first embodiment, the zero-voltage switching is achieved, because the compensation circuit 260 is provided.

Thus, in the first embodiment, in which the parasitic capacitance 270 of the switching element 220 exceeds the capacitance given by the expression (1), the compensation circuit 270 that has inductive impedance is connected in parallel with the switching element 220. Due to this parallel connection, the compensation circuit 260 quickens the discharge of the parasitic capacitance 270 of the switching element 220. Therefore, according to the first embodiment, despite the use of the switching element 220 whose parasitic capacitance 270 is large, the zero-voltage switching of the switching element 220 can be realized. As a result, the contactless electric power transfer of large electric power from the electricity transmission apparatus 100 to the vehicle 200 can be realized with high efficiency.

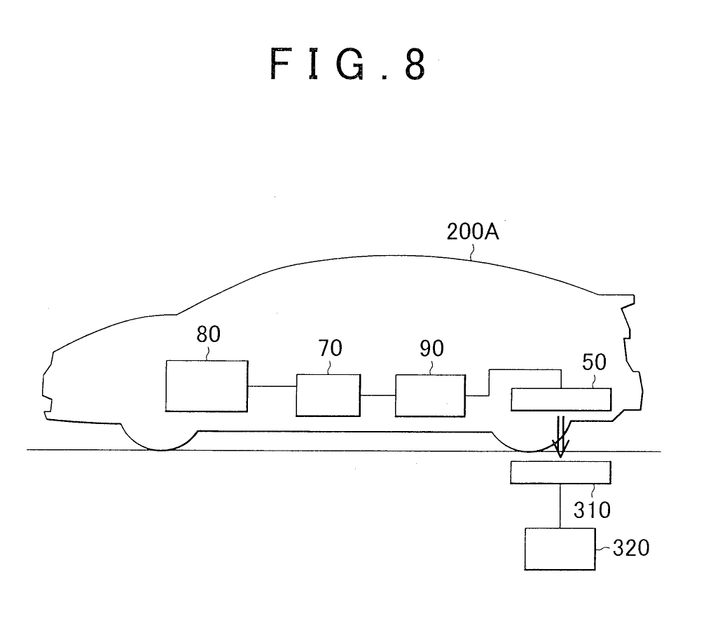

FIG. 8 shows an overall construction diagram of a vehicle to which an electric power supply apparatus according to a second embodiment of the invention is applied. Referring to FIG. 8, a vehicle 200A has substantially the same construction as that of the vehicle 200 shown in FIG. 1, except that the vehicle 200A has an electric power supply apparatus 90 instead of the rectifier circuit 60. That is, in the second embodiment, the electric power supply apparatus 90 is applied to the vehicle 200A that is constructed so as to be able to output electric power to the outside of the vehicle 200A.

The electric power supply apparatus 90, receiving electric power from the electricity storage apparatus 70, produces alternating-current power of high frequency. The construction of the electric power supply apparatus 90 is the same as that of the electric power supply apparatus 20 shown in FIG. 3. Specifically, in the electric power supply apparatus 90, in which the switching element 220 has large rating in order to achieve capability of feeding large amount of electricity from the vehicle 200A to a load 320, the compensation circuit 260 having inductive impedance is connected in parallel with the switching circuit 220, so that the zero-voltage switching of the switching element 220 is realized.

The resonance unit 50 is supplied with alternating-current power of high frequency from the electric power supply apparatus 90, and transfers electric power to a resonance unit 310 that is provided outside the vehicle 200A. The natural frequency of the resonance unit 50 is the same as the natural frequency of the resonance unit 310. The meanings of “natural frequency” and “natural frequencies being the same” are the same as stated above in conjunction with the first embodiment. Outside the vehicle 200A, the resonance unit 310 receives electric power from the resonance unit 50 of the vehicle 200A in a contactless manner, and outputs electric power to a load 320.

According to the second embodiment, although the electric power supply apparatus. 90 of the vehicle 200A employs the switching element 220 whose parasitic capacitance is large, the zero-voltage switching of the switching element 22 can be realized. As a result, the contactless electric power transfer of large electric power from the vehicle 200A to the load 320 can be realized with high efficiency.

Although the first and second embodiments are each described above in conjunction with the case where the corresponding electric power supply apparatus is applied to a contactless electric power transfer system that employs the vehicle, the first and second embodiments are also applicable to contactless electric power transfer systems other than vehicles, for example, cellular phones and mobile phones, home electric appliances, etc.

Besides, although in the foregoing embodiments, electric power is transferred in a contactless manner from the primary-side resonance unit to the secondary-side resonance unit by causing the primary-side resonance unit and the secondary-side resonance unit to resonate with each other in an electromagnetic field, the invention is also applicable to a system in which electric power is transferred from the primary side to the secondary side by electromagnetic induction. That is, in the contactless electric power transfer system shown in FIG. 1, the resonance units 30 and 50 are designed so that the coupling coefficient κ of the resonance unit 30 and the resonance unit 50 is less than or equal to 0.1 and the multiplication product of the coupling coefficient κ and the Q value is greater than or equal to a predetermined value (e.g., 1.0). However, electric power may be transferred from an electricity transmission apparatus to a vehicle by electromagnetic induction by constructing each of the resonance units 30 and 50 from one coil and designing the coils so that the coupling coefficient κ is close to 1.0.

In the foregoing embodiments, the choke coil 210 can be considered to correspond a “first inductor” in the invention. The coil 262 can be considered to correspond to a “second inductor” in the invention. The capacitor 264 can be considered to correspond to a “capacitance element” in the invention. Furthermore, the electric power supply apparatus 20 can be considered to correspond to an “electric power supply portion” in the invention, and the resonance unit 30 can be considered to correspond to an “electricity-transmitting resonance portion” in the invention.

The embodiments disclosed herein are, in all respects, to be considered illustrative and not restrictive. The scope of the invention is shown not by the foregoing description of the embodiments but by the appended claims, and is intended to encompass all the changes and modifications within the meaning and scope equivalent to the claims for patent

1. An electric power supply apparatus comprising:
an amplifier circuit that includes a switching element whose parasitic capacitance is larger than a predetermined capacitance that is needed in order to realize class E zero-voltage switching; and
a compensation circuit that is connected in parallel with the switching element and that has inductive impedance.

2. The electric power supply apparatus according to claim 1,
wherein the amplifier circuit further includes a first inductor and a resonance circuit,
wherein the first inductor is connected between the switching element and a direct-current power supply, and
wherein the resonance circuit is connected between a connecting node and a load connected to the amplifier circuit, the connecting node being connected between the first inductor and the switching element.

3. The electric power supply apparatus according to claim 2, wherein the compensation circuit includes a second inductor and a capacitance element that are connected in series.

4. The electric power supply apparatus according to claim 3, wherein inductance of the second inductor is set at a value where resonance frequency of a circuit formed by the second inductor and the parasitic capacitance of the switching element is substantially equal to switching frequency of the switching element.

5. The electric power supply apparatus according to claim 3, wherein capacitance of the capacitance element is set so that magnitude of impedance of the capacitance element is at least ten times magnitude of impedance of the second inductor.

6. The electric power supply apparatus according to claim 1, wherein the predetermined capacitance is determined by switching frequency of the switching element and a load that is connected to the amplifier circuit.

7. The electric power supply apparatus according to claim 6, wherein the predetermined capacitance is found by an expression below:
C=8/{π(π2+4)CDR}
where C represents the predetermined capacitance, ω=2πi, f represents operating frequency, and R represents magnitude of the load.

8. The electric power supply apparatus according to claim 1, wherein the switching element is constructed of a plurality of switching elements that are connected in parallel with each other.

9. A contactless electricity transmission apparatus that outputs electric power to an electricity reception apparatus in a contactless manner, the contactless electricity transmission apparatus comprising:
an electric powersupply portion that produces alternating-current power; and
an electricity-transmitting resonance portion configured so that alternating-current power supplied from the electric power supply portion is output to an electricity-receiving resonance portion of the electricity reception apparatus in a contactless manner,
wherein natural frequency of the electricity-transmitting resonance portion (30) is equal to the natural frequency of the electricity-receiving resonance portion, and
wherein the electric power supply portion includes an amplifier circuit and a compensation circuit, the amplifier circuit including a switching element whose parasitic capacitance is larger than a predetermined capacitance that is needed in order to realize class E zero-voltage switching, and the compensation circuit being connected in parallel with the switching element and having inductive impedance.

10. The contactless electricity transmission apparatus according to claim 9,
wherein the amplifier circuit further includes: a first inductor and a resonance circuit,
wherein the first inductor is connected between the switching element and a direct-current power supply, and
wherein the resonance circuit is connected between a connecting node and the electricity-transmitting resonance portion, the connecting node being connected between the first inductor and the switching element.

11. The contactless electricity transmission apparatus according to claim 10, wherein the compensation circuit includes a second inductor and a capacitance element that are connected in series.

12. The contactless electricity transmission apparatus according to claim 11, wherein inductance of the second inductor is set at a value where resonance frequency of a circuit formed by the second inductor and the parasitic capacitance of the switching element is substantially equal to switching frequency of the switching element.

13. The contactless electricity transmission apparatus according to claim 11 wherein capacitance of the capacitance element is set so that magnitude of impedance of the capacitance element is at least ten times the magnitude of the impedance of the second inductor.

14. The contactless electricity transmission apparatus according to claim 9, wherein the predetermined capacitance is determined by switching frequency of the switching element and a load that is connected to the amplifier circuit.

15. The contactless electricity transmission apparatus according to claim 14, wherein the predetermined capacitance is found by an expression below:
C=8/{π(π2+4)coR}
where C represents the predetermined capacitance ω=2πi, represents operating frequency, and R represents magnitude of the load.

16. The contactless electricity transmission apparatus according to claim 9, wherein the switching element is constructed of a plurality of switching elements that are connected in parallel with each other.

17. The contactless electricity transmission apparatus according to claim 9, wherein the electricity-transmitting resonance portion transmits electricity to the electricity-receiving resonance portion through at least one of a magnetic field and an electric field, the magnetic field being formed between the electricity-transmitting resonance portion and the electricity-receiving resonance portion and oscillating at a specific frequency, and the electric field being formed between the electricity-transmitting resonance portion and the electricity-receiving resonance portion and oscillating at a specific frequency.

18. The contactless electricity transmission apparatus according to claim 9, wherein a coupling coefficient κ of the electricity-transmitting resonance portion and the electricity-receiving resonance portion is less than or equal to 0.1.

19. The contactless electricity transmission apparatus according to claim 18, wherein the electricity-transmitting resonance portion and a coil of the electricity-receiving resonance portion have a relation in which a multiplication production of the coupling coefficient κ and a Q value is greater than or equal to 1.0.

20. A vehicle that outputs electric power to a load provided outside the vehicle in a contactless manner, the vehicle comprising:
an electricity storage apparatus;
an electric power supply portion that receives electric power from the electricity storage apparatus and produces alternating-current power; and
a resonance portion configured to output the alternating-current power supplied from the electric power supply portion to an electricity-receiving resonance portion provided at a side of the load, in a contactless manner,
wherein natural frequency of the resonance portion is the same as natural frequency of the electricity-receiving resonance portion, and
wherein the electric power supply portion includes an amplifier circuit and a compensation circuit, the amplifier circuit including a switching element whose parasitic capacitance is larger than predetermined capacitance that is needed in order to realize class E zero-voltage switching, the compensation circuit being connected in parallel with the switching element and having inductive impedance.

21. A contactless electric power transfer system comprising:
an electricity reception apparatus that includes an electricity-receiving resonance portion; and
an electricity transmission apparatus that includes an electric power supply portion and an electricity-transmitting resonance portion, the electric power supply portion producing alternating-current power, and the electricity-transmitting resonance portion being configured to output the alternating-current power supplied from the electric power supply portion to the electricity-receiving resonance portion in a contactless manner,
wherein natural frequency of the electricity-receiving resonance portion is the same as natural frequency of the electricity-transmitting resonance portion, and
wherein the electric power supply portion includes an amplifier circuit and a compensation circuit, the amplifier circuit including a switching element whose parasitic capacitance is larger than predetermined capacitance that is needed in order to realize class E zero-voltage switching, the compensation circuit being connected in parallel with the switching element and having inductive impedance.
